(19) United States
(12) Patent Application Publication
(10) Pub. No.: US 2014/0369499 A1
(43) Pub. Date: Dec. 18, 2014

(54) CRYPTOGRAPHIC DEVICE, CRYPTOGRAPHIC PROCESSING METHOD, AND CRYPTOGRAPHIC PROCESSING PROGRAM

(71) Applicant: KABUSHIKI KAISHA TOSHIBA, Tokyo (JP)

(72) Inventor: Takeshi KAWABATA, Kawasaki-shi (JP)

(73) Assignee: KABUSHIKI KAISHA TOSHIBA, Tokyo (JP)

(21) Appl. No.: 14/206,413

(22) Filed: Mar. 12, 2014

(30) Foreign Application Priority Data
Jun. 12, 2013 (JP) 2013-123743

(51) Int. Cl. H04L 9/08

(52) U.S. Cl. CPC H04L 9/0861
USPC 380/47

(57) ABSTRACT

According to an embodiment, a cryptographic device includes a first operation unit that receives a shared key and generates plural expanded keys; and a second operation unit that receives plaintext or ciphertext and performs at least one of encryption and decryption using the expanded keys. First data pieces are obtained by dividing the plaintext into predetermined units of words or obtained by dividing the ciphertext into predetermined units of words. The second operation unit includes a data array determination unit that determines, at a time of encryption, an array order of the first data pieces included in the plaintext as a first order, and determines, at a time of decryption, an array order of the first data pieces included in the ciphertext as a second order; and a main data computation unit that performs, on the first data pieces, computation of at least one of encryption and decryption in the determined order.

### CROSS-REFERENCE TO RELATED APPLICATIONS

This application is based upon and claims the benefit of priority from Japanese Patent Application No. 2013-123743, filed on Jun. 12, 2013; the entire contents of which are incorporated herein by reference.

### FIELD

Embodiments described herein relate generally to a cryptographic device, a cryptographic processing method, and a cryptographic processing program.

### BACKGROUND

A cryptographic device performs encryption on plaintext or decryption on ciphertext by using a specific algorithm. The cryptographic device is used in RFID, an embedded appliance or the like, and is desired to have lower power consumption and to be miniaturized.

As a method of miniaturizing the cryptographic device and reducing the power consumption thereof, reducing a non-linear circuit with a large circuit scale according to Advanced Encryption Standard (AES) by pipelining, and sharing a linear transform circuit between encryption and decryption are known, for example.

However, with respect to a conventional cryptographic device, attention is focused only on the linear transform circuit or the non-linear transform circuit with a large circuit scale, and optimization of computation that is implemented by a selector or the like is insufficient.

### BRIEF DESCRIPTION OF THE DRAWINGS

FIG. 1 is a block diagram illustrating a configuration of a cryptographic device for performing encryption and decryption according to a shared key encryption method;

FIG. 2 is a configuration diagram illustrating an example of a configuration of the cryptographic device in the case where the cryptographic device performs encryption and decryption according to AES;

FIG. 3 is a block diagram illustrating a configuration of a function computation unit;

FIG. 4 is a configuration diagram illustrating an example of a configuration of a data randomizer that divides data into four words and processes the same;

FIG. 5 is a diagram illustrating the update order (the computation order) of expanded keys at the time of encryption and decryption;

FIG. 6 is a block diagram illustrating a configuration of a cryptographic device for performing encryption and decryption according to a shared key encryption method of an embodiment;

FIG. 7 is a configuration diagram illustrating a detailed configuration of a key scheduler of the embodiment;

FIG. 8 is a configuration diagram illustrating a detailed configuration of a data randomizer of the embodiment; and

FIG. 9 illustrates tables illustrating the update order (the computation order) of words for each clock with respect to the cryptographic device of the embodiment.

### DETAILED DESCRIPTION

According to an embodiment, a cryptographic device performs at least one of encryption and decryption according to a shared key encryption method. The device includes a first operation unit and a second operation unit. The first operation unit is configured to receive a shared key and generate a plurality of expanded keys. The second operation unit is configured to receive plaintext or ciphertext and perform at least one of encryption and decryption that uses the plurality of expanded keys. First data pieces are data pieces obtained by dividing the plaintext into predetermined units of words or data pieces obtained by dividing the ciphertext into predetermined units of words. The second operation unit includes a data array determination unit and a main data computation unit. The data array determination unit is configured to determine, at a time of encryption, an array order of the first data pieces included in the plaintext as a first order, and determine, at a time of decryption, an array order of the first data pieces included in the ciphertext as a second order. The main data computation unit is configured to perform, on the first data pieces, computation of at least one of encryption and decryption in the determined order. The second order is the reverse of the first order.

Background

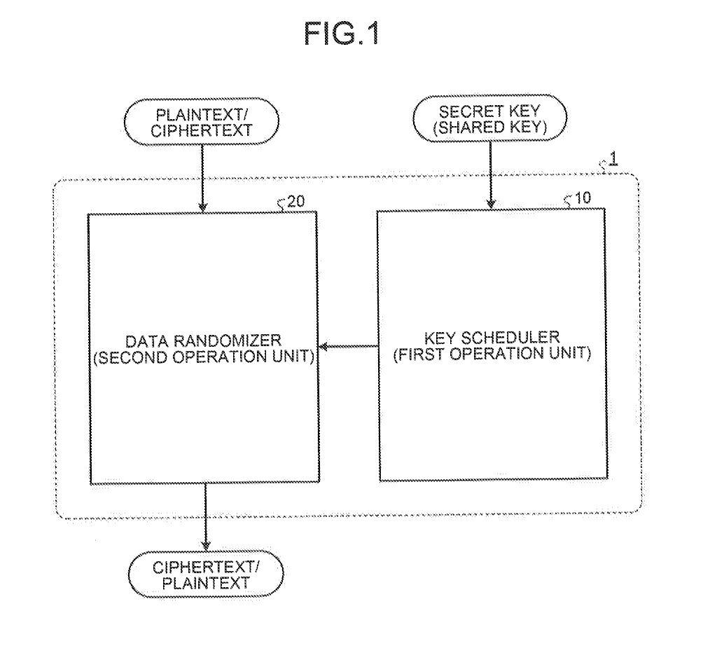

Before describing a cryptographic device according to an embodiment, the background will be first described. FIG. 1 is a block diagram illustrating a configuration of a cryptographic device 1 for performing encryption and decryption according to a shared key encryption method. As illustrated in FIG. 1, the cryptographic device 1 includes a key scheduler (a first operation unit) 10 and a data randomizer (a second operation unit) 20, and performs encryption and decryption according to AES for processing a block cipher, for example. The cryptographic device 1 may be configured partially or wholly by hardware or by software (programs). For example, in the case of being configured by hardware by an ASIC (Application Specific Integrated Circuit) and the like, the cryptographic device 1 is mounted together with a computer including a CPU and a memory. In the case the cryptographic device 1 is configured partially or wholly by software, the software is executed by the CPU or the like.

The key scheduler 10 receives a secret key (a shared key), generates a plurality of expanded keys, and outputs the plurality of expanded keys to the data randomizer 20. The data randomizer 20 receives data of plaintext or ciphertext, and the plurality of expanded keys generated by the key scheduler 10, and performs encryption or decryption.

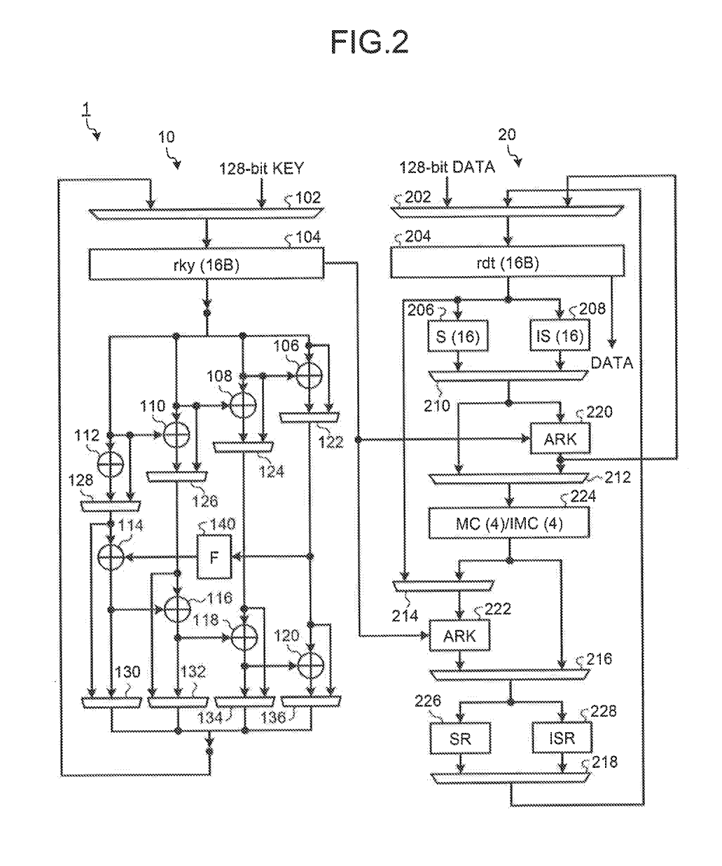

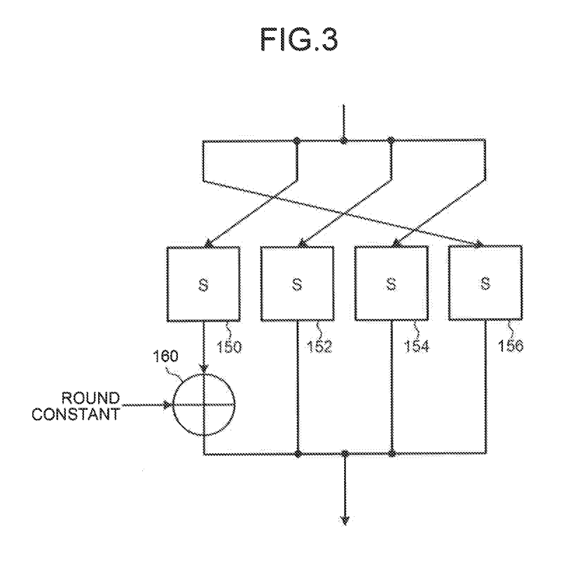

FIG. 2 is a configuration diagram illustrating an example of a configuration of the cryptographic device 1 in the case where the cryptographic device 1 performs encryption and decryption according to AES. In the following, an example where the shared key of AES is of 128 bits will be described. As illustrated in FIG. 2, the key scheduler 10 includes selectors 102, 122, 124, 126, 128, 130, 132, 134 and 136, a register (rky) 104, EXORs (exclusive ORs) 106, 108, 110, 112, 114, 116, 118 and 120, and a function computation unit (F) 140, for example. FIG. 3 is a block diagram illustrating a configuration of the function computation unit 140. As illustrated in FIG. 3, the function computation unit 140 includes Substitution Bytes (hereinafter referred to as “S”) 150, 152, 154 and 156, and an EXOR 160. The Ss 150, 152, 154 and 156 each perform non-linear transformation in units of 8 bits. The EXOR 160 XORs the output of the S 150 and a round constant.

The key scheduler 10 temporarily stores the shared key of 128 bits received via the selector 102 in the register 104 of 16 bytes, and performs update of a key for decryption (generation of an expanded key) by using the EXORs 106, 108, 110, 112 and 114 and the function computation unit (F) 140. The key scheduler 10 temporarily stores the shared key of 128 bits received via the selector 102 in the register 104, and performs update of a key for encryption (generation of an expanded key) by using the EXORs 114, 116, 118 and 120 and the function computation unit (F) 140. The selectors 122, 124, 126, 128, 130, 132, 134 and 136 select data while distinguishing between encryption and decryption.

The data randomizer 20 includes selectors 202, 210, 212, 214, 216 and 218, a register (rdt) 204, a Substitution Byte (S) 206, an inverse Substitution Byte (IS) 208, Add Round Keys (ARKs) 220 and 222, a shared Mix Columns/Inverse Mix Columns (MC/IMC) 224, a Shift Rows (SR) 226, and an Inverse Shift Rows (ISR) 228. The S 206 is configured to achieve 16 one-byte inputs, and divides input data into units of 8 bits and performs non-linear transformation by using a non-linear transformation table. The Ss 150, 152, 154 and 156 mentioned above perform the same process. The IS 208 performs inverse transformation of the S 206. The ARKs 220 and 222 each XOR the expanded key generated by the key scheduler 10 and the data for each bit. The MC/IMC 224 performs linear transformation (inverse transformation is also shared) where mutual influence is exerted on the basis of 8 bits among 32 bits (word: 4 bytes). The SR 226 rearranges data on a per-byte basis. The ISR 228 performs inverse transformation of the SR 226.

Then, in the case of performing encryption, the cryptographic device 1 first stores data (plaintext) received via the selector 202 in the register 204. Next, the cryptographic device 1 performs ARK once in the first clock by using the shared key, and stores the result in the register 204. Next, the cryptographic device 1 repeats, in the second to tenth clocks, the processes in the order of S, SR, MC, and ARK for the specified rounds minus 1, and stores the result of each round in the register 204. Next, the cryptographic device 1 performs, in the eleventh clock, the processes of S, SR and ARK in the final round, and stores the ciphertext according to AES in the register 204. It is noted that the expanded keys used in the ARK in the respective clocks are generated by the key scheduler 10 by using the shared key, and are different from each other. In the case of performing decryption, the cryptographic device 1 performs a process of inverse transformation of the encryption by using the shared key, and stores plaintext according to AES in the register 204.

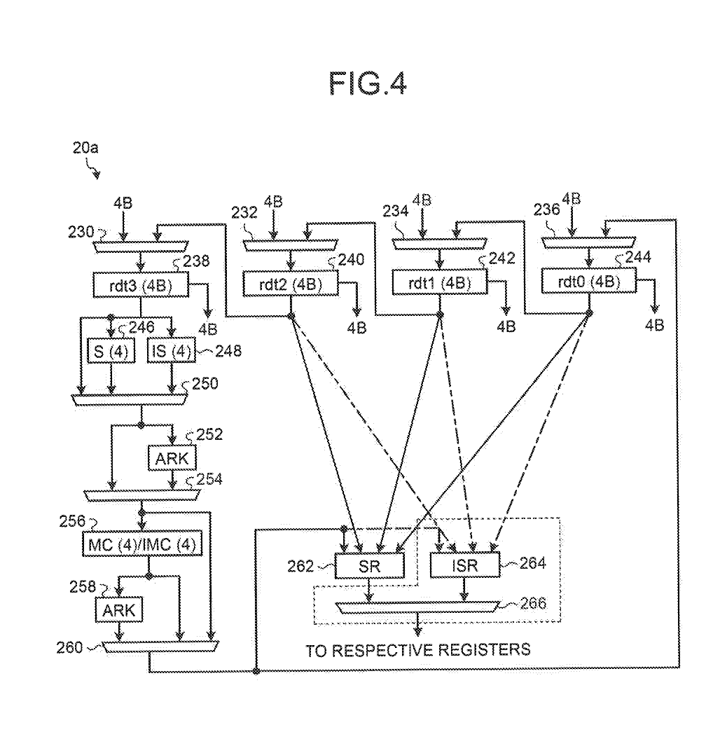

Furthermore, to miniaturize the cryptographic device 1, the cryptographic device 1 may be configured to perform data processing by dividing data of 128 bits (plaintext or ciphertext) into four words (32 bits: 4B). FIG. 4 is a configuration diagram illustrating an example of a configuration of a data randomizer 20a that divides data into four words and processes the same. In the data randomizer 20a illustrated in FIG. 4, each unit that is substantially the same as the unit configuring the data randomizer 20 illustrated in FIG. 2 is denoted with the same reference numeral.

The data randomizer 20a includes selectors 230, 232, 234, 236, 250, 254, 260 and 266, a register (rdt3) 238, a register (rdt2) 240, a register (rdt1) 242, a register (rdt0) 244, an S 246, an IS 248, ARKs 252 and 258, an MC/IMC 256, an SR 262, and an ISR 264.

The selectors 230, 232, 234 and 236 receive words (4B) obtained by dividing data of 128 bits as well as outputs of registers on the lower side different from registers of output destinations; and output words selected according to the rounds. The registers 238, 240, 242 and 244 each store data (word) obtained by dividing. The S 246 is configured to achieve four one-byte inputs, and divides input data in units of 8 bits and performs non-linear transformation by using a non-linear transformation table. The IS 248 performs inverse transformation of the S 246. The selectors 250, 254, 260 and 266 select data while distinguishing between encryption and decryption and distinguishing rounds.

The ARKs 252 and 258 each XOR the expanded key generated by the key scheduler 10 and the data for each bit. The MC/IMC 256 performs linear transformation (inverse transformation is also shared) where mutual influence is exerted on the basis of 8 bits among 32 bits (word: 4 bytes). The SR 262 rearranges data on a per-byte basis. The ISR 264 performs inverse transformation of the SR 262. Then, the data obtained by the SR 262 or the ISR 264 by performing rearrangement on a per-byte basis is stored in each register (the registers 238, 240, 242 and 244) via the selector 266.

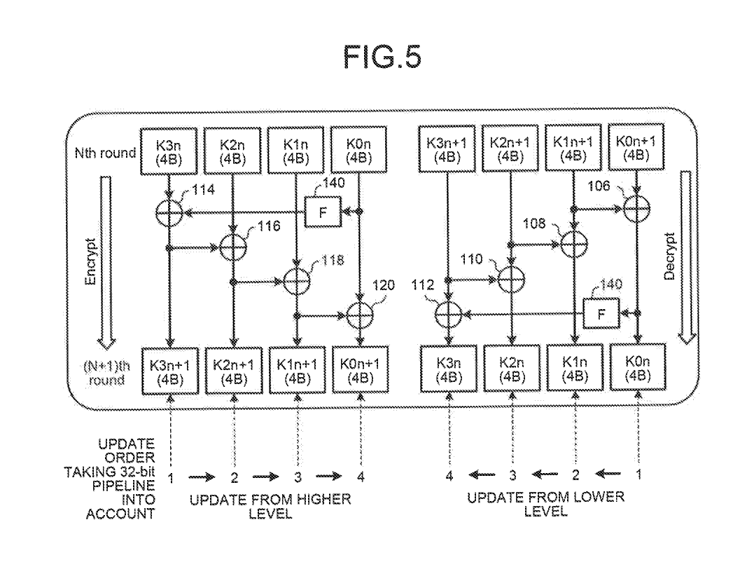

Meanwhile, in the cryptographic device 1, the method of updating the expanded key at the key scheduler 10 is different for encryption and decryption. FIG. 5 is a diagram illustrating the update order (the computation order) of expanded keys at the time of encryption and decryption. As illustrated in FIG. 5, at the time of encryption (Encrypt), the key scheduler 10 updates the expanded key in units of words from a higher-level word (4B), whereas at the time of decryption (Decrypt), the key scheduler 10 updates the expanded key in units of words from a lower-level word.

As described above, the cryptographic device 1 stores, via the selectors, data obtained by performing rearrangement on a per-byte basis in the SR or the ISR, and the update order (the computation order) of the words of the expanded key is different for encryption and decryption.

### Embodiment

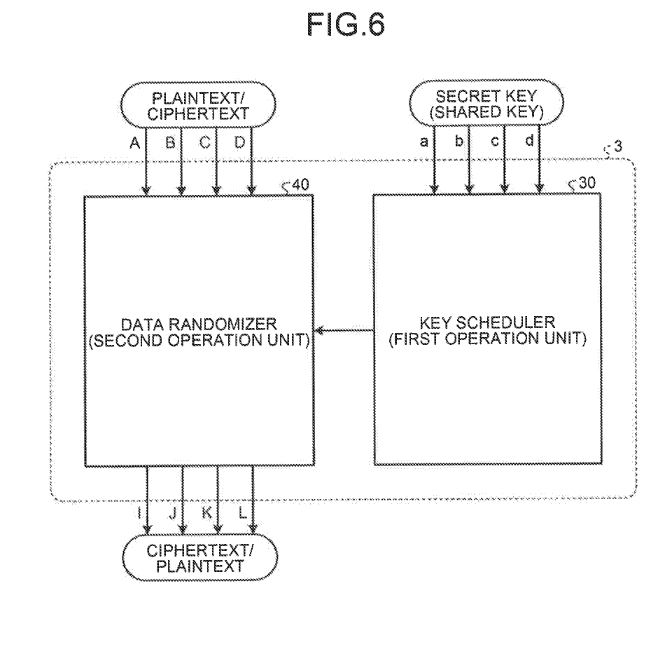

Next, an embodiment of the cryptographic device will be described in detail. FIG. 6 is a block diagram illustrating a configuration of a cryptographic device 3 for performing encryption and decryption according to a shared key encryption method of an embodiment. As illustrated in FIG. 6, the cryptographic device 3 includes a key scheduler (a first operation unit) 30 and a data randomizer (a second operation unit) 40, and performs encryption and decryption according to AES for processing a block cipher, for example. The cryptographic device 3 may be configured partially or wholly by hardware or by software (programs). For example, in the case of being configured by hardware by an ASIC (Application Specific Integrated Circuit) and the like, the cryptographic device 3 is mounted together with a computer including a CPU and a memory. In the case the cryptographic device 3 is configured partially or wholly by software, the software is executed by the CPU or the like.

The key scheduler 30 receives a secret key (a shared key) of 128 bits that is divided into four words (32 bits) of a to d, for example, generates a plurality of expanded keys, and outputs the plurality of expanded keys to the data randomizer 40. The data randomizer 40 receives data of plaintext or ciphertext of 128 bits that is divided into four words (32 bits) of A to D, and the plurality of expanded keys generated by the key scheduler 30, and performs encryption or decryption. The data randomizer 40 outputs a processing result as data of ciphertext or plaintext of 128 bits that is divided into four words (32 bits) of I to L.

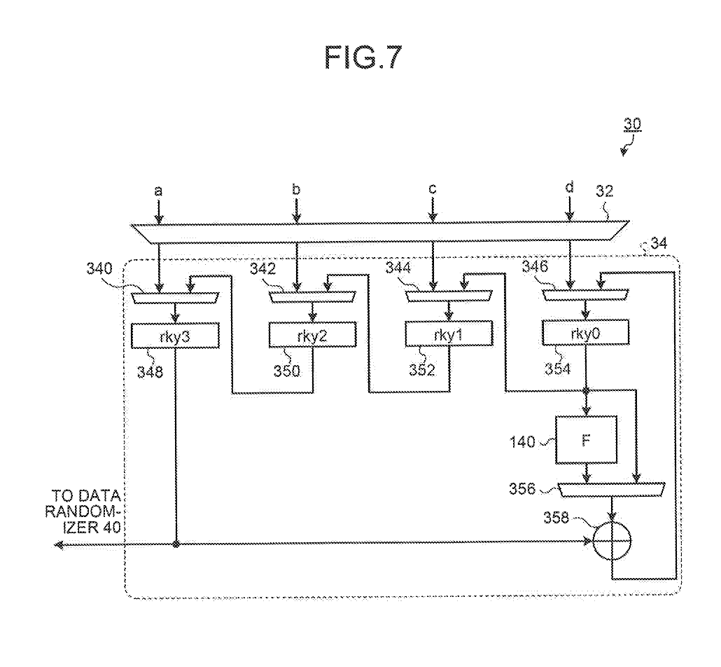

FIG. 7 is a configuration diagram illustrating a detailed configuration of the key scheduler 30 according to the embodiment. As illustrated in FIG. 7, the key scheduler 30 includes a selector 32 and a main expanded key computation unit 34.

The selector 32 receives a shared key of 128 bits that is divided into four words of a to d, for example. The selector 32 distinguishes between encryption and decryption, and determines (selects) the order of words in such a way that the array order of the words is reversed between encryption and decryption. The array order is the arranged order of the words. For example, the selector 32 determines the array order to be a first order at the time of encryption, and determines the array order to be a second order at the time of decryption. The second order is the reverse of the first order.

For example, at the time of encryption, the selector 32 outputs the four words a to d, respectively, to the selectors 340, 342, 344 and 346 of the main expanded key computation unit 34 without changing the array (when the highest level word is given as a and the lowest level word is given as d, without rearranging the order of {a, b, c, d}). On the other hand, at the time of decryption, the selector 32 outputs the four words a to d, respectively, to the selectors 340, 342, 344 and 346 of the main expanded key computation unit 34 after changing the array to the reversed order (when the highest level word is given as a and the lowest level word is given as d, after rearranging the order to {d, c, b, a}). Note that it is enough if the selector 32 selects the words such that the array direction of the words is reversed between encryption and decryption, and it is not restricted to be configured to perform output in the order of {a, b, c, d} at the time of encryption. Alternatively, it may be configured to perform output in the order of (a, d, c, b) at the time of decryption.

That is, the selector 32 has a function as a shared key array determination unit to determine the array of words of a shared key which is divided into units of words such that the array direction of the words of the shared key is reversed between encryption and decryption.

The main expanded key computation unit 34 includes selectors 340, 342, 344, 346 and 356, a register (rky3) 348, a register (rky2) 350, a register (rky1) 352, a register (rky0) 354, a function computation unit (F) 140, and an EXOR 358. The function computation unit 140 illustrated in FIG. 7 is substantially the same as the function computation unit 140 illustrated in FIGS. 2 and 3.

The selectors 340, 342, 344 and 346 receive four words (a to d) obtained by dividing a shared key of 128 bits as well as outputs of registers on the lower side different from registers of output destinations; and output words selected according to the rounds. The registers 348, 350, 352 and 354 each store a divided shared key or expanded key (word). The selector 356 distinguishes between rounds and selects a word. The EXOR 358 XORs the word stored in the register 348 and the word selected by the selector 356.

As described above, according to the key scheduler 30, the selector 32 determines the array of words of a shared key which is divided into units of words such that the array direction of the words of the shared key is reversed between encryption and decryption, and the update order (the computation order) of the words of an expanded key is the same for encryption and decryption.

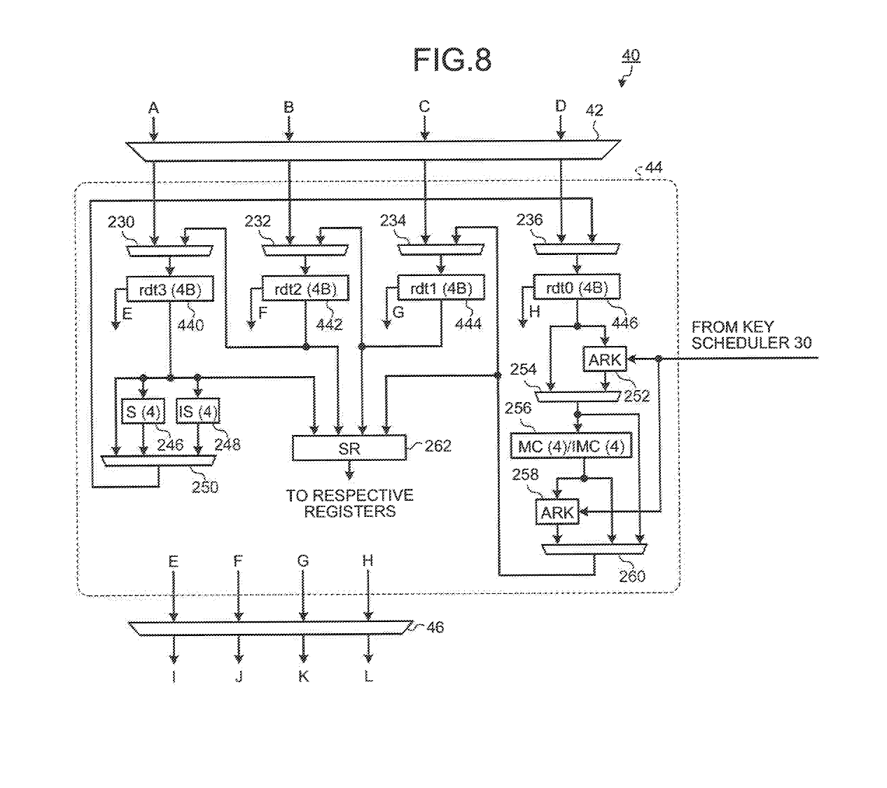

FIG. 8 is a configuration diagram illustrating a detailed configuration of the data randomizer 40. As illustrated in FIG. 8, the data randomizer 40 includes a selector 42, a main data computation unit 44, and a selector 46. With respect to the data randomizer 40 illustrated in FIG. 8, each unit that is substantially the same as the unit configuring the data randomizer 20a illustrated in FIG. 4 is denoted with the same reference numeral.

The selector 42 receives data of 128 bits (plaintext or ciphertext) that is divided into four words of A to D, for example. The selector 42 distinguishes between encryption and decryption, and determines (selects) the order of words in such a way that the array order of the words is reversed between encryption and decryption. The array order is the arranged order of the words. For example, the selector 42 determines the array order of plaintext to be a first order at the time of encryption, and determines the array order of ciphertext to be a second order at the time of decryption. The second order is the reverse of the first order.

For example, at the time of encryption, the selector 42 outputs the four words A to D, respectively, to the selectors 230, 232, 234 and 236 of the main data computation unit 44 without changing the array (when the highest level word is given as A and the lowest level word is given as D, without rearranging the order of {A, B, C, D}). On the other hand, at the time of decryption, the selector 42 outputs the four words A to D, respectively, to the selectors 230, 232, 234 and 236 of the main data computation unit 44 after changing the array to the reversed order (when the highest level word is given as A and the lowest level word is given as D, after rearranging the order to {D, C, B, A}). Note that it is enough if the selector 42 selects the words such that the array direction of the words is reversed between encryption and decryption in accordance with the operation of the key scheduler 30, and it is not restricted to be configured to perform output in the order of (A, B, C, D) at the time of encryption. Alternatively, it may be configured to perform output in the order of (A, D, C, B) at the time of decryption.

That is, the selector 42 has a function as a data array determination unit to determine the array of words of data which is divided into units of words such that the array direction of the words of the data is reversed between encryption and decryption.

The main data computation unit 44 includes selectors 230, 232, 234, 236, 250, 254 and 260, a register (rdt3) 440, a register (rdt2) 442, a register (rdt1) 444, a register (rdt0) 446, an S 246, an IS 248, ARKS 252 and 258, an MC/IMC 256, and an SR 262. The registers 440, 442, 444 and 446 each store data (word) after division.

In the case the selector 42 has performed selection of changing the array direction of the words, the selector 46 performs selection of the words in such a way as to return the array direction of the words to the original array direction. For example, in the case the selector 42 has rearranged the words input in the order of (A, B, C, D) into the order of {D, C, B, A}, the selector 46 receives words E, F, G and H output from the registers 440, 442, 444 and 446, respectively, and performs selection in such a way that the order is in accordance with (A, B, C, D), and outputs words I, J, K and L. That is, the selector 46 has a function as a (second) data array determination unit for determining to return the array of words in data to the original array.

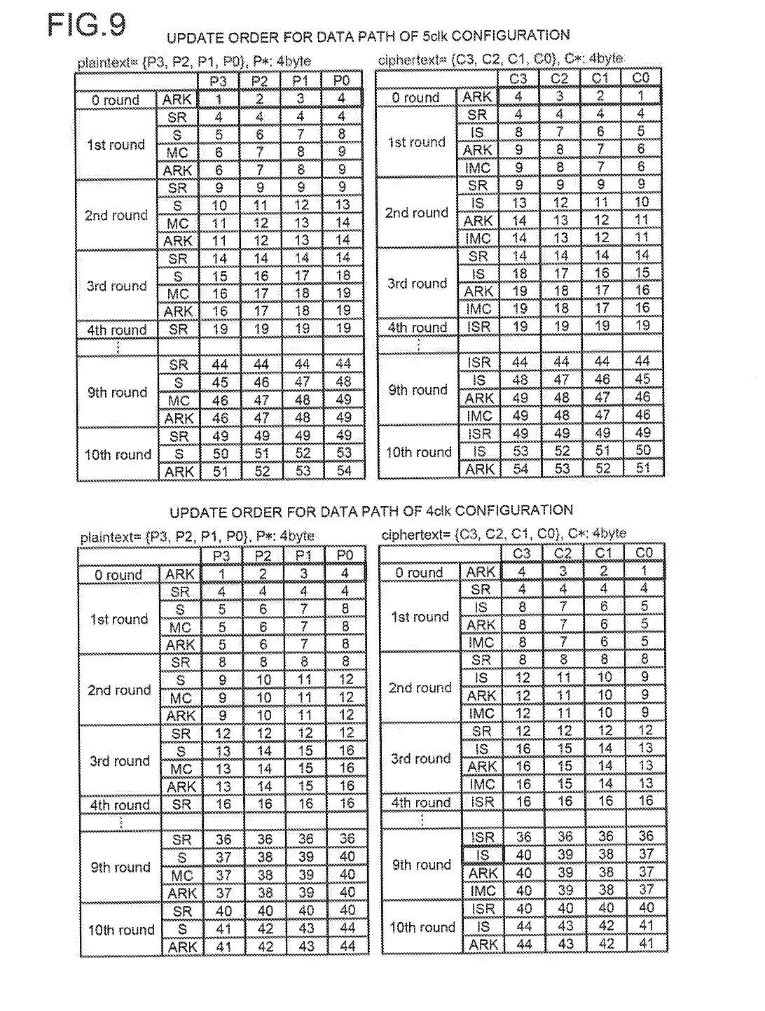

FIG. 9 illustrates tables illustrating the update order (the computation order) of words for each clock in the cryptographic device 3. The numbers indicated for each combination of a process and a word is the number of clocks necessary for the process. As illustrated in FIG. 9, in the case of updating plaintext in a data path in units of 4 bytes (word) in five clocks (5clk), encryption is completed in 54 clocks. In the case of updating ciphertext in a data path in units of 4 bytes (word) in five clocks (5clk), decryption is completed in 51 clocks.

In the case of updating plaintext in a data path in units of 4 bytes (word) in four clocks (4clk), encryption is completed in 44 clocks. In the case of updating ciphertext in a data path in units of 4 bytes (word) in four clocks (4clk), decryption is completed in 41 clocks.

As described above, according to the cryptographic device 3, the update order (the computation order) of words of an expanded key at the key scheduler 30 is the same for encryption and decryption. Moreover, with respect to the data randomizer 40, since the array direction of words of data which is divided into units of words is reversed between encryption and decryption, the computation of the ISR 264 illustrated in FIG. 4 can be performed by the SR 262. Also, the main data computation unit 44 does not include the ISR 264, and thus, does not need the selector 266 illustrated in FIG. 4. That is, the cryptographic device 3 does not need the ISR 264 and the selector 266 illustrated in FIG. 4 that are framed by the dotted line, and thus, miniaturization and lower power consumption may be realized. Particularly, in the case the cryptographic device 3 is configured by hardware such as a semiconductor integrated circuit, the SR 262 and the selector 266 are not in the main data computation unit 44, and thus, miniaturization, power saying, and acceleration are enabled.

It is noted that, in the embodiment described above, a case where a shared key is of 128 bits has been described as an example, but this is not restrictive. For example, the cryptographic device 3 may be configured to perform at least encryption or decryption of a block cipher where the shared key is of 196 bits or 256 bits.

Moreover, with respect to the cryptographic device 3, a case where the key scheduler 30 and the data randomizer 40 each reverse (change) the array of words at the time encryption has been described as an example, but this is not restrictive. For example, the cryptographic device 3 may be configured in such a way that the key scheduler 30 and the data randomizer 40 each reverse the array of words at the time of decryption, and that the main data computation unit 44 performs the process of the SR 262 by the ISR 264 and does not include the SR 262.

Furthermore, the cryptographic device 3 may be configured in such a way that the function of at least one of the selector 32, the selector 42 and the selector 46 is performed by, for example, an external CPU or the like. For example, the cryptographic device 3 may be configured to receive a shared key and generate an expanded key, and to perform computation of encryption or decryption by using the expanded key, on data which is divided into predetermined units of words and for which the array of the words has been determined in such a way that the array direction of the words of the data is reversed between encryption and decryption.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A cryptographic device that performs at least one of encryption and decryption according to a shared key encryption method, the device comprising:
a first operation unit configured to receive a shared key and generate a plurality of expanded keys; and
a second operation unit configured to receive plaintext or ciphertext and perform at least one of encryption and decryption that uses the plurality of expanded keys, wherein
first data pieces are data pieces obtained by dividing the plaintext into predetermined units of words or data pieces obtained by dividing the ciphertext into predetermined units of words,
the second operation unit includes
a data array determination unit configured to determine, at a time of encryption, an array order of the first data pieces included in the plaintext as a first order, and determine, at a time of decryption, an array order of the first data pieces included in the ciphertext as a second order, and
a main data computation unit configured to perform, on the first data pieces, computation of at least one of encryption and decryption in the determined order, and
the second order is the reverse of the first order.

2. The device according to claim 1, wherein
the first operation unit includes
a shared key array determination unit configured to determine an array of words of the shared key which is divided into predetermined units of words in such a way that an array order of the words is reversed between encryption and decryption, and
a main expanded key computation unit configured to perform computation of generating the plurality of expanded keys by using the shared key for which the array of the words has been determined.

3. A cryptographic processing method for performing encryption or decryption according to a shared key encryption method, the method comprising:
receiving a shared key and generating an expanded key; and
performing, on data which is divided into predetermined units of words and for which an array of the words has been determined, computation of encryption or decryption by using the expanded key in such a way that an array order of the words of the data is reversed between encryption and decryption.

4. A computer program product comprising a computer-readable medium containing a cryptographic processing program for performing encryption or decryption according to a shared key encryption method, the program causing a computer to execute:
receiving a shared key and generating an expanded key; and
performing, on data which is divided into predetermined units of words and for which an array of the words has been determined, computation of encryption or decryption by using the expanded key in such a way that an array order of the words of the data is reversed between encryption and decryption.
